(19) United States
(12) Patent Application Publication
(10) Pub. No.: US 2015/0046715 A1
(43) Pub. Date: Feb. 12, 2015

(54) Systems, Methods and Apparatuses for Prevention of Unauthorized Cloning of a Device

(71) Applicant: OLogN Technologies AG, Triesen/FL (LI)

(72) Inventor: Sergey IGNATCHENKO, Innsbruck (AT)

(73) Assignee: OLogN Technologies AG, Triesen/FL (LI)

(21) Appl. No.: 14/452,057

(22) Filed: Aug. 5, 2014

Related U.S. Application Data
(60) Provisional application No. 61/862,798, filed on Aug. 6, 2013.

(51) Int. Cl. G06F 21/44; H04L 9/32

(52) U.S. Cl. CPC G06F 21/44; H04L 9/3268; H04L 9/3247
USPC 713/176; 713/175

(57) ABSTRACT

A self-authenticating device and a method for authenticating the self-authenticating device may be provided. In one aspect, a device may comprise a sensing circuit, which may comprise a circuit to be measured. The sensing circuit may generate measurement data for one or more physical properties of the device using the circuit to be measured. The device may further comprise a storage to store an authenticity certificate that contains authentication data derived from the measurement data and a communication port to communicate the authenticity certificate and measurement data with a communication partner via a link coupled to the communication port.

### RELATED APPLICATIONS

This application claims priority to U.S. Provisional Application No. 61/862,798, filed Aug. 6, 2013, entitled “Systems, Methods and Apparatuses for Prevention of Unauthorized Cloning of a Device,” the content of which is incorporated herein by reference in its entirety.

### FIELD OF THE DISCLOSURE

The systems, methods and apparatuses described herein relate to the authentication of a device.

### BACKGROUND

Cloning of electronic devices is a well-known concern. For example, reverse engineering can be applied to many electronic devices to determine the components and configuration of the devices. During the reverse engineering process, packaged semiconductor chips are often stripped of the package and their circuit layouts exposed. Software used to control the electronic devices is also not immune from reverse engineering. Thus, with the information obtained by reverse engineering, all electronic devices are subject to cloning.

However, susceptibility to cloning is undesirable for a lot of electronic devices. Not only could intellectual property be at risk of theft, illegal clones may be used to cause serious breaches of security. For example, an electronic device may be used for transferring financial information, or may be used for access control to a restricted area. In such situations, if the electronic device is cloned illegally, the illegal copy may be used to transfer financial information or gain access to a restricted area without authorization.

Therefore, there is a need in the art for protection against unauthorized cloning of an electronic device.

### BRIEF DESCRIPTION OF THE DRAWINGS

FIG. 1A is a block diagram of an exemplary system according to the present disclosure.

FIG. 1B is a block diagram of another exemplary system according to the present disclosure.

FIGS. 1C, 1D, 1E,1F and 1G are block diagrams of exemplary sensing circuits according to the present disclosure.

FIG. 2 is a flow diagram illustrating an exemplary process for producing an electronic chip according to the present disclosure.

FIG. 3 is a flow diagram illustrating an exemplary process for a device to be authenticated according to the present disclosure.

### DETAILED DESCRIPTION

Certain illustrative aspects of the systems, apparatuses, and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

The present disclosure provides systems, methods and apparatuses for determining authenticity of a device. In one non-limiting example, a device according to the present disclosure may comprise a chip. The chip may comprise a storage for storing an authenticity certificate and a sensing circuit for generating measurement data for one or more physical properties of the chip. The authenticity certificate may contain the measurement data signed by an authentication device.

In another non-limiting example, a signer device according to the present disclosure may comprise a storage for storing a private key and a signing block. The signer device may be configured to, during an initialization process, establish a connection to a device to be authenticated (e.g., a chip), collect measurement data from the device, generate an authenticity certificate from the collected measurement data and send the generated authenticity certificate to the device for storage. In some embodiments, the signer device may be implemented using a circuit, such as an ASIC, and configured in hardware to perform the above functions. In some other embodiments, the signer device may be implemented using a general purpose computer processor configured by software instructions. In yet some other embodiments, the signer device may be implemented by any combination of hardware and/or software.

In another non-limiting example, an authentication device according to the present disclosure may comprise a storage for storing a public key and a signature verification block. The authentication device may be configured to, during an authentication process, connect to a device (e.g., a chip) to be authenticated, obtain an authenticity certificate from the device, verify the signature of the authenticity certificate, collect measurement data from the device, compare the collected measurement data to that in the authenticity certificate and determine whether the device is authentic. In some embodiments, the authentication device may be implemented using a circuit, such as an ASIC, and configured in hardware to perform the above functions. In some other embodiments, the authentication device may be implemented using a general purpose computer processor configured by software instructions. In yet some other embodiments, the authentication device may be implemented by any combination of hardware and/or software.

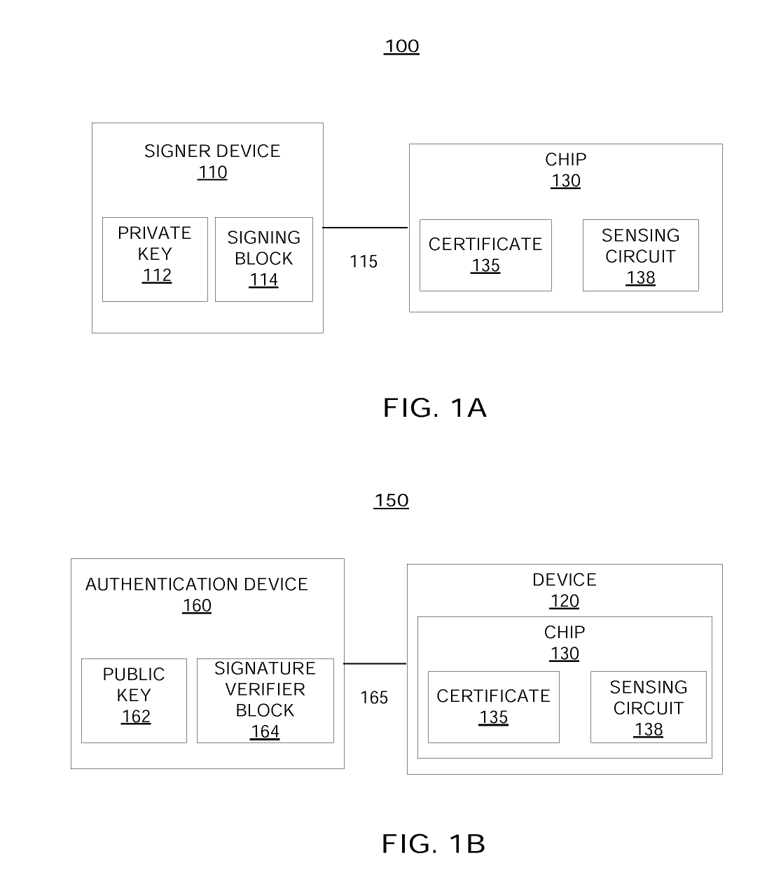

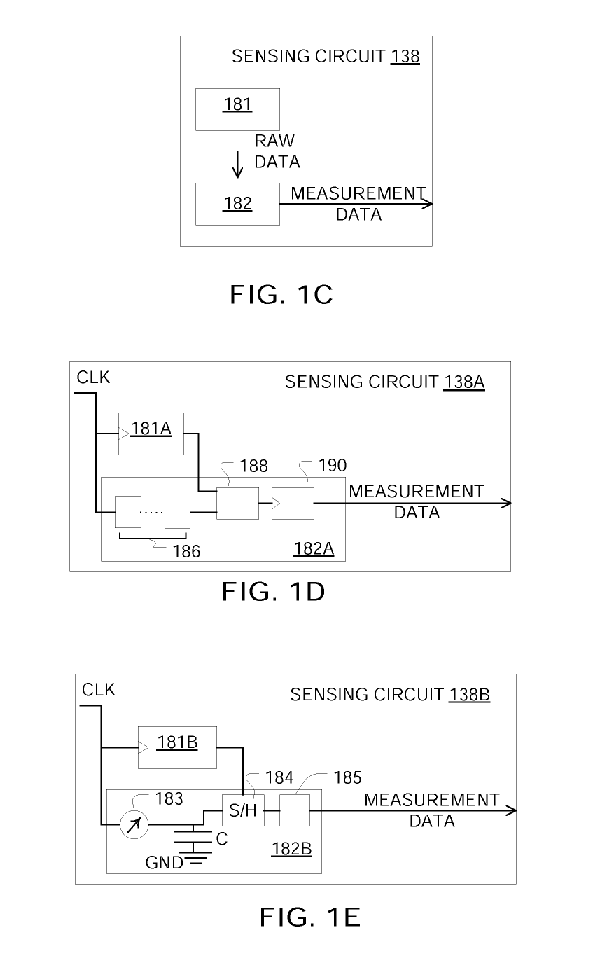

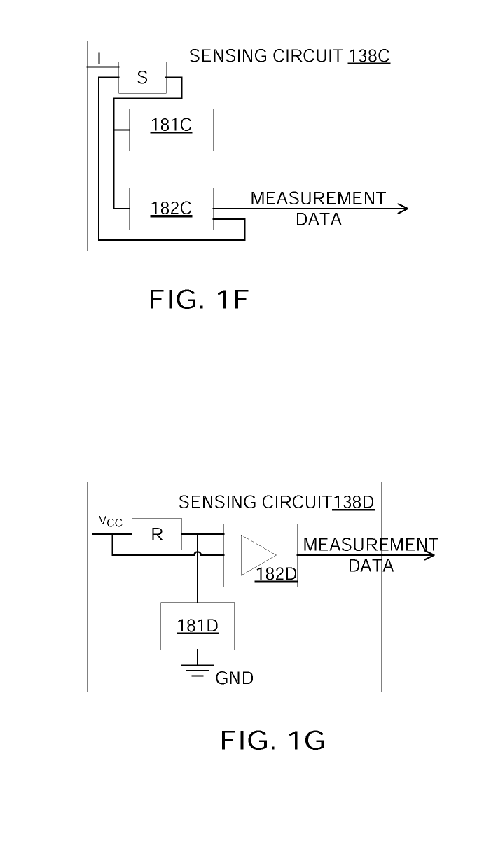

FIG. 1A shows an exemplary system 100 according to the present disclosure. The system 100 may comprise a signer device 110 and a chip 130. The signer device 110 may comprise a storage that stores a private key 112 and a signing block 114. The storage may be, for example, an Erasable Programmable Read Only Memory (EPROM), Flash memory, a hard disk drive (HDD), etc. In some embodiments, the private key storage may be implemented based on a “sealed storage” provided by the Trusted Platform Module, which is defined in “TCG Specification Architecture Overview Specification Revision 1.4,” published August 2007 by the Trusted Computing Group (TCG), the content of which is incorporated by reference in its entirety. The private key 112 may be used by the signing block 114 to sign data as described herein. In a non-limiting example, the private key 112 may be an RSA key, an Elliptic Curve Cryptography (ECC) key, or any other private key for any public/private cryptography algorithm known in the art or developed in the future. The signing block 114 may be any combination of hardware and/or software capable of performing encryption and/or signing operations. Non-limiting examples include one or more ASICs, FPGAs, SoCs, or microprocessors or microcontrollers running appropriate software.

The chip 130 may comprise a sensing circuit 138 and a storage for storing an authenticity certificate 135. In some embodiments, the authenticity certificate 135 may be stored in an on-chip programmable non-volatile memory (such as a PROM, EPROM, EEPROM, Flash memory, etc.). In some other embodiments, the authenticity certificate 135 may be stored outside of the chip 130. For example, the authenticity certificate 135 may be stored on a device hosting the chip 130, such as the device 120 shown in FIG. 1B. In another example of such embodiments, the authenticity certificate 135 may be stored in an external database (not shown), and identified, for example, by a chip serial number. The chip serial number, for example, may be stored on chip 130, or in device 120.

The sensing circuit 138 may be used to measure one or more physical properties of the chip, such as, for example, leakage current of specific MOSFET transistor or several specific MOSFET transistors, delay on a specific path, power consumed by a specific circuit during specific operations and so on. The measurement data may be signed by the signing block 114 of the signer device 110 using the key 112 during an initialization process. The signing process may generate a result based or derived from the measurement data and that result may be saved as the authenticity certificate 135.

The chip 130 and the signer device 110 may be connected by a link 115. The link 115 may be any suitable type of connection, such as wired, wireless, etc. The wired connection may be for example, an IEEE 1194.1 (JTAG TAP) interface, System Management Bus (SMBus), I²C bus, but any other connection is also suitable. For example, a serial or parallel connection based on currently available technology (such as, USB, IEEE 1394, RJ-45, etc.), or other connection types developed in the future, may also be used as the wired connection. The wireless connection may be any wireless communication currently available (such as, NFC, Bluetooth, WiFi, radio, etc.) or developed in the future. Although not shown, the chip 130 and the signer device 110 may respectively comprise appropriate communication ports for the link 115.

FIG. 1B shows an exemplary system 150 according to the present disclosure. The system 150 may comprise an authentication device 160 and a device 120 to be authenticated. The authentication device 160 may comprise a storage that stores a public key 162 and a signature verifier block 164. The storage may be, for example, an Erasable Programmable Read Only Memory (EPROM), a Flash memory, hard disk drive (HDD), etc. The key 162 may be a public key that corresponds to a private key 112 of a signer device 110, so that any signature generated using a private key 112 may be validated using the public key 162. Signature authentication may be performed by the signature verifier block 164. The signature verifier block 164 may be any combination of hardware and/or software capable of performing decryption and/or signature verification operations. Non-limiting examples include one or more ASICs, FPGAs, SoCs, or microprocessors or microcontrollers running appropriate software.

The device 120 may comprise a chip 130 as that shown in FIG. 1A. The device 120 and the authenticating device 160 may be connected by a link 165. The link 165 may be similar to the link 115, and may be any suitable type of connection, such as wired, wireless, etc. The wired connection may be for example, an IEEE 1194.1 (JTAG TAP) interface, SMBus, I²C bus, but any other connection is also suitable. For example, a serial or parallel connection based on currently available technology (such as, USB, IEEE 1394, RJ-45, etc.), or other connection types developed in the future, may also be used as the wired connection. The wireless connection may be any wireless communication currently available (such as, NFC, Bluetooth, WiFi, radio, etc.) or developed in the future. Although not shown, the device 120 and the authentication device 160 may respectively comprise appropriate communication ports for the link 165.

In some embodiments, the links 115 and 165 may be the same kind of connection. For example, the device 120 may have a communication port for external connection directly mapped to the communication port of the chip 130. That is, the device 120 may have a communication port that is identical to that of the chip 130, with each pin or socket linked to a corresponding pin or socket of the chip 130. In some other embodiments, the links 115 and 165 may be different kinds of connection. For example, the device 120 may have circuits between the chip 130 and its communication port for the link 165 that manipulate or transform the data on the way to and from the chip 130.

In some embodiments, the device 120 may be used in sensitive tasks (e.g., financial transactions, access control, medical testing equipments, etc.) and may need to be authenticated during use. Examples of an authentication device 160 and a sensitive device 120 include, respectively, a terminal and an access card; a mission-critical system, such as, for example, an airplane and a control block for such a system; a medical device and a replaceable component of the medical device, etc.

The signer device 110 may be a device that is used by an authorized party to initialize the chip 130. In some embodiments, the initialization process may be performed during the process of manufacturing the chip 130. For example, the signer device 110 may be a part of Automated Testing Equipment (ATE) used during the chip manufacturing process. In some other embodiments, the initialization process may be performed after the chip 130 has been put into the device 120. Either as a standalone device or as part of an ATE, the signer device 110 may be implemented in hardware, software, or a combination of hardware and software.

Although not shown, each of the device 120, the signer device 110, and the authentication device 160 may further include hardware and/or software elements configured to perform some or all functionalities. The hardware elements may include electronic circuits, such as Central Processing Units, microprocessors, microcontrollers, field programmable gate arrays (FPGAs), application specific integrated circuits (ASICs), System on a Chip (SoC), or any combination thereof. In some embodiments, the functionalities described herein may be implemented in hardware configuration. In some other embodiments, the circuits may be configured to execute software modules that implement the functionalities described herein. In yet some other embodiments, the functionalities described herein may be implemented by a combination of hardware and software.

As shown on FIG. 1C, the sensing circuit 138 may comprise a circuit to be measured 181 and a measurement circuit 182. “Raw data” may be generated by the circuit to be measured 181. The measurement circuit 182 may be a circuit configured to measure, and optionally process, the raw data to generate measurement data. The measurement data may be represented as electrical signals, for example, as digital electrical signals. In some embodiments, the raw data may also be represented and interpreted as electrical signals. In some other embodiments, the raw data may be represented by some other means. For example, in one exemplary embodiment, the raw data may be the amount of heat generated by the circuit to be measured 181 or the temperature reached by the circuit to be measured 181 while performing a predefined operation, and this raw data may be measured by a temperature sensor, which may be a part of the measurement circuit 182, to produce measurement data.

In some embodiments, the circuit to be measured 181 may be an electronic circuit already existing on the chip 130 for some other purposes. In some other embodiments, the circuit 181 may be specially constructed on the chip 130 for the measurement purpose. In some embodiments, the circuit to be measured 181 may be as simple as a circuit point at a pre-determined location of the chip 130. In some embodiments, if raw data is represented by electrical signals, the measurement circuit 182 may be as simple as one or more wires generating an output signal from the raw data.

There are a variety of ways to implement the sensing circuit 138. Some examples for implementing the sensing circuit 138 are described herein but they are merely exemplary and not exclusive. Moreover, although the term sensing circuit 138 is used as a singular term, the chip 130 may comprise a plurality of sensing circuits for different physical properties and/or same physical property at different locations in the chip 130.

It should also be noted that on FIGS. 1A and 1B the sensing circuit 138 is shown as part of the chip 130. In some embodiments, however, a measurement circuit like the measurement circuit 182 may be implemented on the signer device 110 and/or the authentication device 160. In those embodiments, the measurement data may be generated by the measurement circuit on the signer device 110 and/or the authentication device 160.

In some embodiments, if the raw data is represented by electrical signals, the chip 130 and device 120 may comprise an additional connector interface, which would provide the raw data from the circuit to be measured 181, to other devices, such as authentication device 160 or to signer device 110. Thus, a signer device 110 or authentication device 160 may either use measurement data obtained over the link 115 or 165, or may use data coming directly from this additional connector interface. In some of such embodiments, the authentication device 160 may perform a comparison between two measurements of the circuit to be measured 181. One measurement may be made by the on-chip measurement circuit 182 and the measurement data obtained via the link 165. Another measurement may be made by a measurement circuit in the authentication device 160, which may obtain the raw data from the circuit to be measured 181 via the additional connector interface. If data from these two measurements unreasonably differ from each other, the authentication device 160 may determine that the chip 130, and hence the device 120, is not authentic. In some embodiments, the two measurements may be made at approximately the same time. Moreover, in some embodiments, the measurement circuit 182 and/or the measurement circuit in the authentication device 160 may be calibrated to account for system errors in the measurement circuits.

In one non-limiting example, the chip 130 may comprise a plurality of sensing circuits 138. In embodiments with a plurality of sensing circuits 138, for some of the sensing circuits, both the circuit to be measured 181 and measurement circuit 182 may be implemented on the chip 130, while for other of the sensing circuits, the circuit to be measured 181 may be implemented on the chip 130 and the measurement circuit 182 may be implemented on the signer device 110 and/or authentication device 160.

FIG. 1D shows an exemplary implementation of the sensing circuit 138. This exemplary implementation may be referred to as the sensing circuit 138A, which may comprise a circuit to be measured 181A and a measurement circuit 182A. In one non-limiting example, the physical property to be measured may be a delay between an edge of an input clock and an edge of one of the outputs of circuit to be measured 181A. The input clock is labeled as “CLK” in FIG. 1D, and may be fed to both the circuit to be measured 181A and measurement circuit 182A. In some embodiments, any input to the circuit to be measured 181A that is changed in the current clock cycle may be used as the input “CLK” on FIG. 1D.

In one embodiment, the delay may be measured, for example, by comparing the delay of the circuit to be measured 181A with a delay of an inverter (or repeater) chain. For example, the measurement circuit 182A may comprise a chain 186 of a predetermined number of inverters or repeaters, a comparator 188 and a flip-flop 190. The comparator 188 may have two inputs: one connected to an output of the chain 186 of inverters or repeaters, and another connected to an output of the circuit to be measured 181A. This output of the circuit to be measured 181A may change in the same direction as the input clock within the current clock cycle. The comparator 188 may generate an output indicative of the length of the delay in the circuit to be measured 181A. In one non-limiting example, the comparator 188 may be an XOR logical gate. The XOR logical gate may xor the output of the chain of inverters (or repeaters) with the output of the circuit to be measured 181A. The xor-ed result may be connected to the flip-flop 190's clock input to see if a static hazard, which is long enough to cause the flip-flop 190 to trigger, has occurred. Whether the flip-flop 190 is triggered may be indicative of whether the delay through circuit 181A is within a time period d_{T} of the delay through the chain 186 of invertors, wherein d_{T} is the time sufficient to trigger the flip-flop 190. In some embodiments, the same measurement may be repeated for different lengths of inverter or repeater chains to obtain more information. It should be noted that in some embodiments, dynamic hazards may be utilized in a similar manner.

As used herein, a hazard may refer to a phenomenon in which changes in the input variables cause a temporary change in output due to some form of delay. For example, a static hazard may occur because two signal paths have different delays, and the length of the hazard may be roughly equal to the difference in delays along the two paths. In one non-limiting embodiment, the first path may be the path via the circuit 181A, and the second path may be the path via the chain of invertors/repeaters. Whether the flip-flop has triggered may indicate whether the hazard is long enough to trigger the flip-flop, and thus may be used to effectively determine whether the difference in delays between the two paths is more or less than a constant, i.e., the threshold difference to trigger the flip-flop.

FIG. 1E illustrates another embodiment for measuring delay. In this embodiment, a sensing circuit 138B may comprise a circuit to be measured 181B and a measurement circuit 182B. The measurement circuit 182B may comprise a current source 183, a capacitor C, a sample-and-hold circuit 184 and a voltage measurement circuit 185. The delay may be measured by using the input clock of the circuit to be measured 181B to control the current source 183 so that the current source may generate current only after a CLK signal has arrived. The current generated by the current source 183 may be used to charge the capacitor C. An output of the circuit to be measured 181B may be used to control the sample-and-hold circuit 184, which may sample the voltage on the capacitor C at the time when the output of the circuit to be measured 181B changes. In this embodiment, the voltage measurement circuit 185 may be coupled to an output of the sample-and-hold circuit 184. The voltage at the output of the sample-and-hold circuit 184 may be measured to determine the delay of the circuit to be measured 181B.

In some embodiments, a measurement circuit for measuring the delay in the circuit 181A or 181B may be implemented on a signer device 110 or on an authentication device 160. In these embodiments, measurement may be performed, for example, between an edge of an input clock and an edge of one of the output pins of chip 130.

Another non-limiting implementation for the sensing circuit 138 is illustrated in FIG. 1F. As shown in FIG. 1F, a sensing circuit 138C may comprise a circuit to be measured 181C and a measurement circuit 182C. When performing a measurement, the measurement circuit 182C may disconnect the input of circuit to be measured 181C from a regular input I, and then measure the leakage current on the input of the circuit to be measured 181C. For example, the measurement circuit 182C may measure a MOSFET leakage current from the input of the circuit to be measured 181C. The disconnection may be achieved, for example, by the switch S. In some embodiments, the measurement may be performed on more than one input of the circuit to be measured 181C. In some embodiments, a measurement circuit for measuring leakage current may be implemented on the signer device 110 or authentication device 160. In these embodiments, measurement of leakage current may be performed, for example, on one or more of the inputs of the chip 130.

In one non-limiting example, the leakage current may be measured as described in “Test Circuit for Extremely Low Gate Leakage Current Measurement of 10 aA for 80,000 MOSFETs in 80s”, Kumagai, Y. et al., 2012 IEEE International Conference on Microelectronic Test Structures (ICMTS), the entirety of which is incorporated herein by reference. Other methods of measuring leakage current, known in the art or developed in the future, may also be used.

Another exemplary implementation for the sensing circuit 138 is illustrated in FIG. 1G. As shown in FIG. 1G, a sensing circuit 138D may comprise a resistor R, a circuit to be measured 181D and a measurement circuit 182D. A voltage supply Vcc may be applied to the resistor R. The measurement circuit 182D may measure power consumption of the circuit to be measured 181D. In one non-limiting example, the power consumption may be measured by measuring the voltage difference across the resistor R. In some embodiments, the resistor R may be placed between the circuit 181D GND connector and the ground. Other implementations of power consumption measurement, known in the art or developed in the future, may also be used.

In some embodiments, power consumption may be measured while the circuit to be measured 181D is idle. In some other embodiments, power consumption may be measured while a pre-defined task is performed by the circuit to be measured 181D.

In some embodiments, a measurement circuit for measuring power consumption may be implemented on the signer device 110 or on the authentication device 160. In these embodiments, the measurement may be performed, for example, on one or more of the power supply pins of chip 130.

In some embodiments, one physical property to be measured by the sensing circuit 138 may be the frequency generated by an on-chip oscillator. For example, the circuit to be measured 181 may comprise an oscillator, such as, for example, multivibrator or ring oscillator. In some embodiments, the oscillator may be thermo- and/or voltage-stabilized. The measurement circuit may measure the frequency generated by the oscillator. For example, if the oscillator frequency is measured by the measurement circuit 182 on the chip 130, the chip 130 may use an external or internal clock as a reference base to perform the frequency measurement.

In some embodiments, the physical property to be measured may be a temperature change in a certain physical point after the circuit to be measured 181 performs a predefined task, which may be for example, a predefined complicated calculation. In such embodiments, the measurement circuit 182 may comprise a temperature sensor to measure the temperature in a certain point, which may be located near the circuit to be measured 181, before and after the task is performed. In some embodiments, the temperature sensor may be located within the chip 130, for example, as an on-chip cell. In some other embodiments, a measurement circuit may be located within a signer device 110 and/or authentication device 160 to receive and process raw data from such a temperature sensor.

In some embodiments, environmental information may be taken into account as factors affecting a measured physical property. Exemplary environmental information may include temperature and/or voltage information. The voltage information may comprise a variety of voltages, such as power supply voltage Vcc, back bias voltage, etc. In one non-limiting example, if the physical property being measured is oscillator frequency, then during the initialization process, a signer device 110 may collect the measurements for the oscillator frequency, temperature and/or voltage data, sign the collected measurement data and store the signed data as part of the authenticity certificate 135. When an authentication device 160 performs authentication, it may collect the current temperature and/or voltage data from the chip 130 and obtain the stored temperature and/or voltage data from the authenticity certificate 135, and use a pre-determined oscillator frequency-temperature curve and/or frequency-voltage curve to normalize the currently measured frequency and stored frequency before comparing them.

Normalization as used herein may refer to the technique of processing a measured data point according to one or more known factors. For example, the oscillator frequency may be dependent on the temperature and voltage. The dependency relationship may be provided in a pre-determined oscillator frequency-temperature curve and/or frequency-voltage curve. These curves may be, for example, obtained by measurements on a plurality of test chips 130 or calculated based on known dependencies of oscillator frequency on temperature or voltage, and may be stored, for example, within the authentication device 160. Alternatively, these curves may be stored at some other location but available to the authentication device 160 when needed.

In some embodiments, instead of storing the collected temperature and/or voltage during the initialization process as a part of the authenticity certificate, the signer device 110 may store the oscillator frequency normalized to some pre-defined temperature and/or voltage. Accordingly, during the authentication process, the authentication device 160 may compare a normalized currently collected oscillator frequency data to that stored within the authenticity certificate 135.

In some embodiments, a normalization technique may also be applied to other physical properties measured by the sensing circuit 138 to reduce the effects of environmental factors such as temperature, voltage, and/or operating frequency. Moreover, in some embodiments, any measurement data as described herein may be collected several times with different environmental parameters (such as voltage, operating frequency or temperature) applied to the relevant circuit on the chip 130. In some embodiments, some of these environmental parameters (such as operating frequencies or voltages) may be supplied externally, or may be generated within the chip 130 according to instructions from the signer device 110 and/or authentication device 160.

It should be noted that in some embodiments, the sensing circuit 138 may combine more than one sensing circuits for the same or different physical properties described above. For example, there may be different sensing circuits for temperature and voltage, and/or different sensing circuits for voltages at different places on the chip 130.

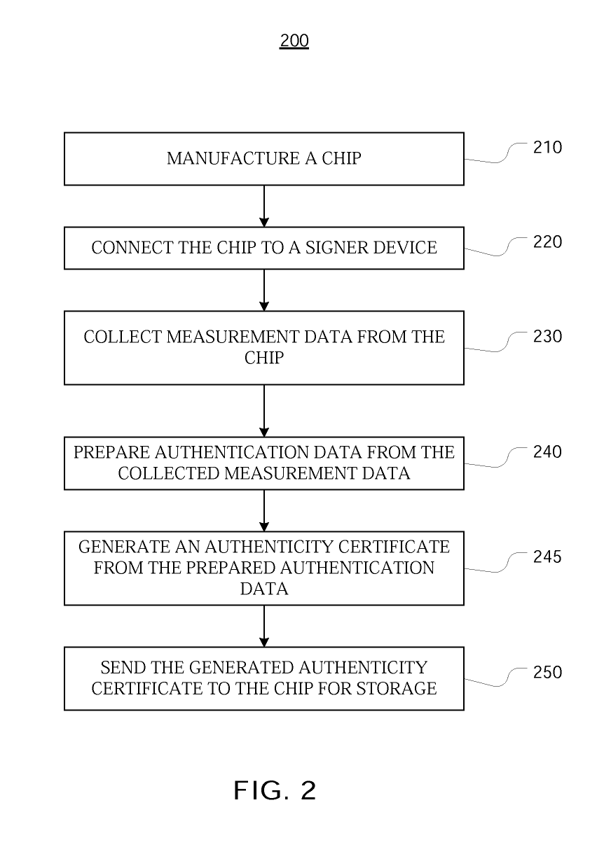

FIG. 2 is a flow diagram illustrating an exemplary method 200 according to one embodiment of the present disclosure. The method 200 shows an initialization process of a chip 130. It should be noted that the initialization process as described herein may be performed by a signer device 110. In some embodiments, the initialization process may be performed before the chip 130 is put into the device 120.

At block 210, a chip is manufactured. As a non-limiting example, a chip 130 may be manufactured as an ASIC or a VLSI. In another non-limiting example, a chip 130 may be produced by programming an FPGA.

At block 220, the chip may be connected to a signer device 110, for example, via the link 115. This block may be performed, for example, right after the chip is manufactured. In some embodiments, the block 220 may be combined with an ASIC/VLSI testing as a part of the manufacturing process.

At block 230, measurement data may be collected from the chip. For example, the sensing circuit 138 of the chip 130 may generate measurement data for one or more physical properties. As described herein, the measurement may depend on the type of the sensing components in the sensing circuit 138.

At block 240, authentication data may be prepared from the measurement data collected from the chip. In some embodiments, authentication data may include information derived from the measurement data collected from the sensing circuit 138 of the chip 130. For example, in one non-limiting embodiment, instead of an absolute value, an expected range of values may be used as a part of an authentication data. Such a range, may take into account expected variations due to allowed changes in environmental parameters observed during authenticity validation versus environmental parameters observed during chip initialization. In another non-limiting embodiment, the range of all possible values may be divided into a set of sub-ranges, and a sub-range to which a measured value belongs may be specified as a part of authentication data.

At block 245, the prepared authentication data may be signed by the signer device 110 to form an authenticity certificate 135. The signer device 110 may use the key 112 and signing block 114 for signing the prepared authentication data. In some embodiments, the authenticity certificate 135 may also include information in addition to the prepared authentication data, such as, for example, manufacturer id, chip type, chip allowed usage, etc.

At block 250, the authenticity certificate generated in the signer device 110 may be sent to the chip for storage. Accordingly, each chip 130 according to the present disclosure may have its own authenticity certificate 135 that is based on measurement data from the chip's sensing circuit 138 and is signed by a private key 112 of a signer device 110. The chip 130 may be put into a device 120 for authentication of the device 120. It should be noted that in some embodiments, a chip 130 may be put into a device 120 first before performing this initialization process 200. In those embodiments, the connection to the chip 130 may be through a connector of the device 120, such as the link 165 of FIG. 2.

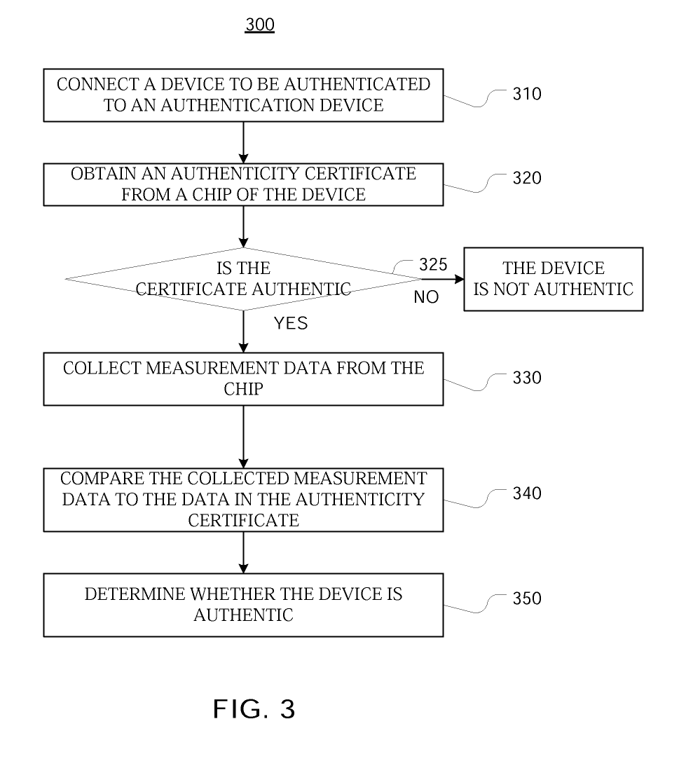

FIG. 3 is a flow diagram illustrating an exemplary method 300 for validating authenticity of a chip 130 using an authentication device 160. Because the chip 130 is hosted by the device 120 during authentication, the device 120 may be determined to be authentic when the chip 130 is authentic. At block 310, the authentication device 160 may be connected to the device 120. The connection may be, for example, the connection 165 shown in FIG. 1B. At block 320, the authentication device 165 may obtain the authenticity certificate 135 from the chip 130 of the device 120. The authenticity certificate 135 may be obtained, for example, through the connection 165.

At block 325, the authenticity certificate 135 may be validated. For example, the authenticity certificate 135 may be validated using the public key 162, which corresponds to the private key 112 of the signer device 110. The public key 162 may be stored at the authentication device 160 or made available to the authentication device 160 through a trusted third party. In some embodiments, the authentication device 160 may store a root certificate and use PKI signature validation procedures to validate the authenticity certificate 135. The root certificate may be, for example, a certificate from a certificate authority (CA). If the authenticity certificate 135 is not valid, the authenticating device 160 may determine that the chip 130 and/or the device 120 is not authentic. If the authentication certificate is valid, the method may proceed to block 330.

At block 330, the authentication device 160 may collect current measurement data from the sensing circuit 138 of the chip 130.

At block 340, the authentication device 160 may compare the current measurement data to the authentication data obtained from the authenticity certificate 135. As described herein, in some embodiments, such a comparison may take into consideration the potential difference between results from the current measurements and results obtained from the authenticity certificate. In some embodiments, an “expected range” of measurement values may be pre-defined and in some of these embodiments, such an expected range may be a part of the authenticity certificate.

In some embodiments, whether the authentication device 160 considers the comparison to be successful may depend on whether all sensing circuits generate data within their respective expected ranges. In some embodiments, the ranges may be specified in or derived from the data in authenticity certificate 135. In some other embodiments, whether the authentication device 160 considers a comparison to be successful may depend on whether a predetermined number of sensing circuits generate measurement data within expected ranges.

In some other embodiments, the decision whether a comparison is successful may be based on weights assigned to each sensing circuit or each type of sensing circuit. For example, weights for sensing circuits that generate measurement data within their respective expected ranges may be added together, and the sum may be compared to a pre-defined total weight threshold. If the sum passes the total weight threshold, the comparison may be determined to be successful. It should be noted that in some embodiments, there can be two different weights for the same sensing circuit—one weight for generating measurement data within the range, and another weight for generating measurement data outside the range. For example, if a voltage measurement is within an expected range, a positive weight (e.g., 10) may be added to the sum, but if it is outside of the expected range, a negative weight an order of magnitude greater than the positive weight (e.g., 100) may be added to the sum to reduce the sum. In some further embodiments, weights may differ depending on how far the measured value is from an expected value. For example, if in the example above the voltage measurements are on the boundary of the expected range, no weight (e.g. zero) may be added to the sum.

In some other embodiments, whether a comparison is successful may be determined based on testing a statistical hypothesis that the current measurement data corresponds to the authentication data obtained from the authenticity certificate 135. For example, the measurement data generated by a particular sensing circuit may have a distribution of error. Such an error distribution may be obtained, for example, by multiple testing of the sensing circuit, by theoretical reasoning, or by any other suitable method. It should be noted that data generated by different sensing circuits may have different error distributions in general. In some embodiments, information about this error distribution may be made available to the authentication device 160. For example, the error distribution information may be a part of information stored inside the authenticity certificate 135, or may be preloaded to the authentication device 160, or may be acquired by the authentication device 160 during the process of comparison (e.g., loaded from an external source, such as, the Internet, etc.). With the error distribution information, a probability that the chip 130 is authentic may be calculated based on the difference between the value of measured data from the authenticity certificate 135 and a result from the current measurement. In some embodiments, a predefined threshold may be used so that if a calculated probability is less than the threshold value the authentication device 160 may consider a chip not authentic. The predefined threshold value may be 0.8, 0.9, 0.95, 0.98, 0.99, etc., and may be defined based on the physical properties being involved in the probability calculations.

It should be noted that there are a number of ways to test a hypothesis. For example, in one embodiment, a chi-square method may be used. In this embodiment, N sensing circuits, where N is one or greater, may be used, and the authenticity certificate 135 may contain N values. At block 320, N current measurement results may be collected by the authentication device 160. At block 340, a hypothesis evaluation may be performed, in which the authentication device 160 may consider each of N values in the authenticity certificate 135 as an expected value, and a respective current measurement result as an observed value. Then a chi-square value, such as, for example, a Pearson's cumulative test statistic value, may be calculated for the N measure results. The chi-squared statistic value may then be used to calculate a probability, which may be referred to as a “p-value” as known in the art.

At block 350, whether the chip 130 and/or device 120 is authentic may be determined by the authentication device 160. For example, if the comparison in block 340 is successful, the chip 130 and/or device 120 may be considered authentic. Otherwise, it may be considered not authentic. It should also be noted that methods described above may be used together. For example, in one embodiment, to determine whether a chip is authentic, the authentication device 160 may apply an “expected range” method to data related to some number of sensing circuits, and a chi-square method to data related to other remaining sensing circuits. If either of two tests fail, the chip may be considered not authentic.

While specific embodiments and applications of the present invention have been illustrated and described, it is to be understood that the invention is not limited to the precise configuration and components disclosed herein. The terms, descriptions and figures used herein are set forth by way of illustration only and are not meant as limitations. Various modifications, changes, and variations which will be apparent to those skilled in the art may be made in the arrangement, operation, and details of the apparatuses, methods and systems of the present invention disclosed herein without departing from the spirit and scope of the invention. By way of non-limiting example, it will be understood that the block diagrams included herein are intended to show a selected subset of the components of each apparatus and system, and each imaged apparatus and system may include other components which are not shown on the drawings. Additionally, those with ordinary skill in the art will recognize that certain steps and functionalities described herein may be omitted or re-ordered without detracting from the scope or performance of the embodiments described herein.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of microprocessors, microcontrollers, field programmable gate arrays (FPGAs), application specific integrated circuits (ASICs), and/or System on a Chip (SoC)—but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD or any other form of storage medium known in the art.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

What is claimed is:

1. A device, comprising:
a sensing circuit comprising a circuit to be measured, the sensing circuit to generate measurement data for one or more physical properties of the device using the circuit to be measured;
a storage to store an authenticity certificate that contains authentication data derived from the measurement data; and
a communication port to communicate the authenticity certificate and measurement data with a communication partner via a link coupled to the communication port.

2. The device of claim 1, wherein the authenticity certificate is received via the communication port and stored in the storage.

3. The device of claim 1, wherein the one or more physical properties include one or more of the following: an amount of heat generated or a temperature reached by the circuit to be measured on the device, a leakage current of a specific MOSFET transistor or several specific MOSFET transistors, a delay on a specific path, power consumed by a specific circuit during specific operations, and a frequency generated by an on-chip oscillator.

4. The device of claim 1, wherein the sensing circuit is configured to measure environmental information when taking measurement of the one or more physical properties.

5. The device of claim 4, wherein the environmental information include one or more of: power supply voltage, back bias voltage, and temperature.

6. The device of claim 5, wherein the authentication data includes signed data of the environment information.

7. The device of claim 5, wherein the authentication data stored in the authenticity certificate is normalized to some pre-defined temperature and/or voltage.

8. A method for authenticating a device to protect from an unauthorized clone, comprising:
obtaining an authenticity certificate from the device;
determining whether the authenticity certificate is authentic;
collecting measurement data from the device for one or more physical properties of the device,
comparing the collected measurement data to authentication data contained in the authenticity certificate; and
determining whether the device is authentic based on the comparison result.

9. The method of claim 8, wherein the one or more physical properties include one or more of the following: an amount of heat generated or a temperate reached by the circuit to be measured on the device when the circuit to be measured is performing a predefined operation, a leakage current of a specific MOSFET transistor or several specific MOSFET transistors, a delay on a specific path, power consumed by a specific circuit during specific operations, and a frequency generated by an on-chip oscillator.

10. The method of claim 8, wherein the authentication data includes signed data of environment information.

11. The method of claim 10, wherein the environmental information include one or more of: power supply voltage, back bias voltage, and temperature.

12. The method of claim 10, wherein the authentication data stored in the authenticity certificate is normalized to some pre-defined temperature and/or voltage.

13. The method of claim 8, wherein whether the device is determined to be authentic depends on whether the collected measurement data is within an expected range.

14. The method of claim 13, wherein the expected range is predefined.

15. The method of claim 13, wherein the expected range is derived from data in the obtained authenticity certificate.

16. The method of claim 8, wherein comparing the collected measurement data to the authentication data in the authenticity certificate comprises assigning weights to at least some of measured data.

17. The method of claim 8, wherein comparing the collected measurement data to the authentication data in the authentication certificate comprises calculating a probability that the device is authentic.

18. The method of claim 17, wherein calculating the probability that the device is authentic comprises verifying a statistical hypothesis that the collected measurement data corresponds to the authentication data obtained from the authenticity certificate.

19. The method of claim 18, wherein verifying the statistical hypothesis comprises using a chi-square method on multiple measurement results and determining that a p-value is greater than a predefined threshold.

20. An authentication apparatus for authenticating a device; comprising:
a storage for storing a public key;
a signature verification block configured to use the public key to authenticate authenticity certificates;
a communication port; and
a processor configured to:
establish a connection to the device to be authenticated through the communication port;
obtain an authenticity certificate from the device through the communication port;
collect measurement data from the device for one or more physical properties of the device;
compare the collected measurement data to authentication data in the authenticity certificate; and
determine whether the device is authentic based on the comparison result.

21. The authentication apparatus of claim 20, wherein the one or more physical properties include one or more of the following: an amount of heat generated or a temperate reached by a circuit to be measured on the device when the circuit to be measured is performing a predefined operation, a leakage current of a specific MOSFET transistor or several specific MOSFET transistors, a delay on a specific path, power consumed by a specific circuit during specific operations, and a frequency generated by an on-chip oscillator.

22. The authentication apparatus of claim 20, wherein to compare the collected measurement data to the authentication data in the authentication certificate is to verify that the received measurement data is within an expected range.

23. The authentication apparatus of claim 22, wherein the expected range is predefined.

24. The authentication apparatus of claim 22, wherein the expected range is derived from the data in authenticity certificate.

25. The authentication apparatus of claim 20, wherein to compare the collected measurement data to the authentication data in the authentication certificate comprises assigning weights to at least some of measured data.

26. The authentication apparatus of claim 20, wherein to compare the collected measurement data to the authentication data in the authentication certificate comprises to calculate a probability that the device is authentic.

27. The authentication apparatus of claim 26, wherein to calculate the probability that the device is authentic comprises to verify a statistical hypothesis that the collected measurement data corresponds to the authentication data obtained from the authenticity certificate.

28. The authentication apparatus of claim 27, wherein to verify the statistical hypothesis comprises using a chi-square method on multiple measurement results and determining that a p-value is greater than a predefined threshold.
